(19) United States
(12) Patent Application Publication
(10) Pub. No.: US 2019/0283802 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hideki Matsunaga, Wako-shi (JP); Masamitsu Tsuchiya, Wako-shi (JP); Yasuharu Hashimoto, Wako-shi (JP); Etsuo Watanabe, Wako-shi (JP)

(21) Appl. No.: 16/296,337

(22) Filed: Mar. 8, 2019

(30) Foreign Application Priority Data
Mar. 14, 2018 (JP) 2018-046880

(51) Int. Cl. B62D 15/02; B62D 6/00

(52) U.S. Cl. CPC B62D 15/0265; G05D 1/0088; B62D 6/001

(57) ABSTRACT

A vehicle control device (100) includes a recognizer (130) that recognizes a surrounding situation of a vehicle and a driving controller (140, 160) that automatically controls at least steering of the vehicle on the basis of the surrounding situation recognized by the recognizer, wherein the driving controller is configured to, when the recognizer has recognized a single pedestrian ahead in a travel direction of the vehicle, make a distance between the vehicle and the pedestrian equal to or greater than a first minimum interval and to, when the recognizer has recognized a plurality of pedestrians ahead in the travel direction of the vehicle, make the distance between the vehicle and a pedestrian closest to the vehicle equal to or greater than a second minimum interval which is greater than the first minimum interval.

### CROSS-REFERENCE TO RELATED APPLICATION

Priority is claimed on Japanese Patent Application No. 2018-046880, filed Mar. 14, 2018, the content of which is incorporated herein by reference.

### BACKGROUND

### Field of the Invention

The present invention relates to a vehicle control device, a vehicle control method, and a storage medium.

### Description of Related Art

A pedestrian detection system that detects a pedestrian present near a vehicle and prevents contact with the detected pedestrian is known in the related art. A technology in which a laser radar mounted on a vehicle emits laser light, illuminated points that are considered as corresponding to a pedestrian or a group of pedestrians among points illuminated with laser light are grouped, and a pedestrian or a pedestrian group is detected on the basis of the width of the spread of the grouped illuminated points and the moving speed of the center thereof is also known in the related art (for example, Japanese Unexamined Patent Application, First Publication No. 2000-3499).

### SUMMARY

However, how to adjust the minimum interval between the vehicle and the detected pedestrian or pedestrian group is not taken into consideration in the technology of the related art. If the vehicle is an automatically driven vehicle, steering control for avoiding contact with the detected pedestrian or pedestrian group is automatically performed. However, in this case, steering control is supposed to be performed merely according to the movement of a pedestrian closest to the vehicle, and thus appropriate driving control sometimes cannot be performed.

Aspects of the present invention have been made in view of such circumstances and it is an object of the present invention to provide a vehicle control device, a vehicle control method, and a storage medium with which it is possible to more appropriately perform driving control for avoiding contact with pedestrians present ahead in the travel direction of an own vehicle.

A vehicle control device, a vehicle control method, and a storage medium according to the present invention adopt the following configurations.

(1) A vehicle control device according to an aspect of the present invention includes a recognizer configured to recognize a surrounding situation of a vehicle, and a driving controller configured to automatically control at least the steering of the vehicle on the basis of the surrounding situation recognized by the recognizer, wherein the driving controller is configured to, when the recognizer has recognized a single pedestrian ahead in a travel direction of the vehicle, make a distance between the vehicle and the pedestrian equal to or greater than a first minimum interval and to, when the recognizer has recognized a plurality of pedestrians ahead in the travel direction of the vehicle, make the distance between the vehicle and a pedestrian closest to the vehicle equal to or greater than a second minimum interval which is greater than the first minimum interval.

(2) In the vehicle control device according to the above aspect (1), the driving controller is configured to, when the recognizer has recognized a plurality of pedestrians ahead in the travel direction of the vehicle, adjust the second minimum interval on the basis of respective amounts of movement of the plurality of recognized pedestrians in a width direction of a road.

(3) In the vehicle control device according to the above aspect (1), the driving controller is configured to, when the recognizer has recognized a plurality of pedestrians ahead in the travel direction of the vehicle and a pedestrian present further from a center in a width direction of a road among the plurality of pedestrians has approached a pedestrian present closer to the center in the width direction of the road, make the distance between the vehicle and a pedestrian closest to the vehicle equal to or greater than a third minimum interval which is greater than the second minimum interval.

(4) In the vehicle control device according to the above aspect (3), the driving controller is configured to adjust the second minimum interval or the third minimum interval on the basis of respective attributes of the plurality of pedestrians recognized by the recognizer.

(5) A vehicle control method according to an aspect of the present invention includes a vehicle control device recognizing a surrounding situation of a vehicle, automatically controlling at least the steering of the vehicle on the basis of the recognized surrounding situation, and automatically controlling the steering of the vehicle such that, when a single pedestrian ahead in a travel direction of the vehicle has been recognized, a distance between the vehicle and the pedestrian is equal to or greater than a first minimum interval and, when a plurality of pedestrians ahead in the travel direction of the vehicle have been recognized, the distance between the vehicle and a pedestrian closest to the vehicle is equal to or greater than a second minimum interval which is greater than the first minimum interval.

(6) A storage medium according to an aspect of the present invention is a computer readable non-transitory storage medium storing a program causing a vehicle control device to recognize a surrounding situation of a vehicle, to automatically control at least the steering of the vehicle on the basis of the recognized surrounding situation, and to automatically control the steering of the vehicle such that, when a single pedestrian ahead in a travel direction of the vehicle has been recognized, a distance between the vehicle and the pedestrian is equal to or greater than a first minimum interval and, when a plurality of pedestrians ahead in the travel direction of the vehicle have been recognized, the distance between the vehicle and a pedestrian closest to the vehicle is equal to or greater than a second minimum interval which is greater than the first minimum interval.

According to any of the above aspects (1) to (6), it is possible to more appropriately perform driving control for avoiding contact with pedestrians present ahead in the travel direction of the own vehicle.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of processing of a circumventing travel controller when a single pedestrian is present ahead in the travel direction of an own vehicle.

FIG. 4 is a diagram showing an example of processing of a circumventing travel controller when a plurality of pedestrians are present ahead in the travel direction of the own vehicle.

FIG. 5 is a diagram showing an example of processing of the circumventing travel controller based on the amount of movement of a plurality of pedestrians in a lateral direction.

FIG. 6 is a (first) diagram showing an example of processing of the circumventing travel controller based on attributes of pedestrians.

FIG. 7 is a (second) diagram showing an example of processing of the circumventing travel controller based on attributes of pedestrians.

FIG. 8 is a flowchart showing the flow of processes executed by the automated driving control device according to an embodiment.

FIG. 9 is a diagram showing an example of the hardware configuration of an automated driving control device according to an embodiment.

### DESCRIPTION OF EMBODIMENTS

Hereinafter, embodiments of a vehicle control device, a vehicle control method, and a storage medium of the present invention will be described with reference to the drawings. The following description will be given with reference to the case in which left-hand traffic laws are applied, but the terms “left” and “right” simply need to be read in reverse when right-hand traffic laws are applied.

### [Overall Configuration]

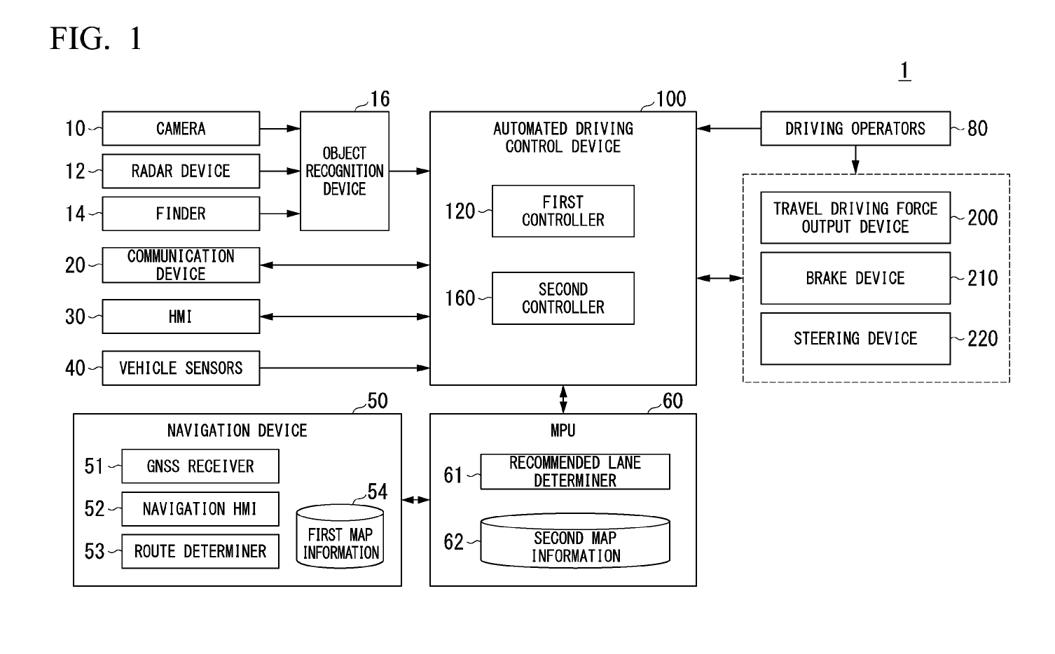

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera 10, a radar device 12, a finder 14, an object recognition device 16, a communication device 20, a human machine interface (HMI) 30, vehicle sensors 40, a navigation device 50, a map positioning unit (MPU) 60, driving operators 80, an automated driving control device 100, a travel driving force output device 200, a brake device 210, and a steering device 220. These devices or apparatuses are connected to each other by a multiplex communication line or a serial communication line such as a controller area network (CAN) communication line, a wireless communication network, or the like. The components shown in FIG. 1 are merely an example and some of the components may be omitted or other components may be added. The automated driving control device 100 is an example of the “vehicle control device.”

The camera 10 is, for example, a digital camera using a solid-state imaging device such as a charge coupled device (CCD) or complementary metal oxide semiconductor (CMOS) image sensor. The camera 10 is attached to the vehicle in which the vehicle system 1 is mounted (hereinafter referred to as an own vehicle M) at an arbitrary location. For imaging the area in front of the vehicle, the camera 10 is attached to an upper portion of a front windshield, a rear surface of a rearview mirror, or the like. For example, the camera 10 repeats imaging of the surroundings of the own vehicle M at regular intervals. The camera 10 may also be a stereo camera.

The radar device 12 radiates radio waves such as millimeter waves around the own vehicle M and detects radio waves reflected by an object (reflected waves) to detect at least the position (distance and orientation) of the object. The radar device 12 is attached to the own vehicle M at an arbitrary location. The radar device 12 may detect the position and velocity of an object using a frequency modulated continuous wave (FM-CW) method.

The finder 14 is a light detection and ranging (LIDAR) finder. The finder 14 illuminates the surroundings of the own vehicle M with light and measures scattered light. The finder 14 detects the distance to a target on the basis of a period of time from when light is emitted to when light is received. The light radiated is, for example, pulsed laser light. The finder 14 is attached to the own vehicle M at an arbitrary location.

The object recognition device 16 performs a sensor fusion process on results of detection by some or all of the camera 10, the radar device 12, and the finder 14 to recognize the position, type, speed, or the like of the object. The object recognition device 16 outputs the recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

For example, the communication device 20 communicates with other vehicles near the own vehicle M using a cellular network, a Wi-Fi network, Bluetooth (registered trademark), dedicated short range communication (DSRC) or the like or communicates with various server devices via wireless base stations.

The HMI 30 presents various types of information to an occupant in the own vehicle M and receives an input operation from the occupant. The HMI 30 includes various display devices, a speaker, a buzzer, a touch panel, switches, keys, or the like.

The vehicle sensors 40 include a vehicle speed sensor that detects the speed of the own vehicle M, an acceleration sensor that detects the acceleration thereof, a yaw rate sensor that detects an angular speed thereof about the vertical axis, an orientation sensor that detects the orientation of the own vehicle M, or the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 specifies the position of the own vehicle M on the basis of signals received from GNSS satellites. The position of the own vehicle M may also be specified or supplemented by an inertial navigation system (INS) using the output of the vehicle sensors 40. The navigation HMI 52 includes a display device, a speaker, a touch panel, a key, or the like. The navigation HMI 52 may be partly or wholly shared with the HMI 30 described above. For example, the route determiner 53 determines a route from the position of the own vehicle M specified by the GNSS receiver 51 (or an arbitrary input position) to a destination input by the occupant (hereinafter referred to as an on-map route) using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The on-map route is output to the MPU 60. The navigation device 50 may also perform route guidance using the navigation HMI 52 on the basis of the on-map route. The navigation device 50 may be realized, for example, by a function of a terminal device such as a smartphone or a tablet possessed by the occupant. The navigation device 50 may also transmit the current position and the destination to a navigation server via the communication device 20 and acquire a route equivalent to the on-map route from the navigation server.

The MPU 60 includes, for example, a recommended lane determiner 61 and holds second map information 62 in a storage device such as an HDD or a flash memory. The recommended lane determiner 61 divides the on-map route provided from the navigation device 50 into a plurality of blocks (for example, into blocks each 100 meters long in the direction in which the vehicle travels) and determines a recommended lane for each block by referring to the second map information 62. The recommended lane determiner 61 determines the number of the lane from the left in which to travel. When there is a branch point on the on-map route, the recommended lane determiner 61 determines a recommended lane such that the own vehicle M can travel on a reasonable route for proceeding to the branch destination.

The second map information 62 is map information with higher accuracy than the first map information 54. The second map information 62 includes, for example, information of the centers of lanes or information of the boundaries of lanes. The second map information 62 may also include road information, traffic regulation information, address information (addresses/postal codes), facility information, telephone number information, or the like. The second map information 62 may be updated as needed by the communication device 20 communicating with another device.

The driving operators 80 include, for example, an accelerator pedal, a brake pedal, a shift lever, a steering wheel, a different shaped steering member, a joystick, and other operators. Sensors for detecting the amounts of operation or the presence or absence of operation are attached to the driving operators 80. Results of the detection are output to the automated driving control device 100 or some or all of the travel driving force output device 200, the brake device 210, and the steering device 220.

The automated driving control device 100 includes, for example, a first controller 120 and a second controller 160. Each of these components is realized, for example, by a hardware processor such as a central processing unit (CPU) executing a program (software). Some or all of these components may be realized by hardware (including circuitry) such as large scale integration (LSI), an application specific integrated circuit (ASIC), a field-programmable gate array (FPGA), or a graphics processing unit (GPU) or may be realized by hardware and software in cooperation. The program may be stored in a storage device such as an HDD or a flash memory in the automated driving control device 100 in advance or may be stored in a detachable storage medium such as a DVD or a CD-ROM and then installed in the HDD or the flash memory in the automated driving control device 100 by inserting the storage medium into a drive device. A combination of the behavior plan generator 140 and the second controller 160 is an example of the “driving controller.” The driving controller automatically controls at least the steering of the own vehicle M among the speed or the steering thereof on the basis of a surrounding situation recognized by the recognizer 130.

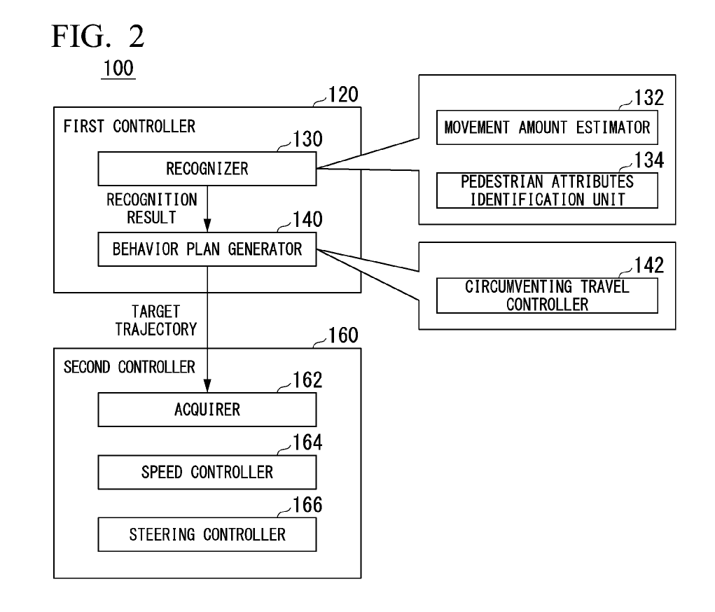

FIG. 2 is a functional configuration diagram of the first controller 120 and the second controller 160. The first controller 120 includes, for example, a recognizer 130 and a behavior plan generator 140. For example, the first controller 120 realizes a function based on artificial intelligence (AI) and a function based on a previously given model in parallel. For example, the function of “recognizing an intersection” is realized by performing recognition of an intersection through deep learning or the like and recognition based on previously given conditions (presence of a signal, a road sign, or the like for which pattern matching is possible) in parallel and evaluating both comprehensively through scoring. This guarantees the reliability of automated driving. The recognizer 130 recognizes states of objects present near the own vehicle M such as the position, speed and acceleration thereof on the basis of information input from the camera 10, the radar device 12, and the finder 14 via the object recognition device 16. The objects include, for example, obstacles such as pedestrians, moving objects such as other vehicles, and construction sites. The position of an object is recognized, for example, as a position in an absolute coordinate system whose origin is at a representative point on the own vehicle M (such as the center of gravity or the center of a drive shaft thereof), and used for control. The position of the object may be represented by a representative point on the object such as the center of gravity or a corner thereof or may be represented by an expressed region. When the object is another vehicle, the “states” of the object may include an acceleration or jerk of the object or a “behavior state” thereof (for example, whether or not the object is changing or is going to change lanes). When the object is a pedestrian, the “states” of the object may include the moving direction of the object or a “behavior state” thereof (for example, whether or not the object is traversing or is going to transverse a road). The recognizer 130 may also recognize the amount of movement of the object in a sampling period.

The recognizer 130 recognizes, for example, a lane (road) in which the own vehicle M is traveling. For example, the recognizer 130 recognizes the traveling lane, for example, by comparing a pattern of road lane lines (for example, an arrangement of solid and broken lines) obtained from the second map information 62 with a pattern of road lane lines near the own vehicle M recognized from an image captured by the camera 10. The recognizer 130 may also recognize the traveling lane by recognizing travel boundaries (road boundaries) including road lane lines, road shoulders, curbs, a median strip, guardrails, or the like, without being limited to road lane lines. This recognition may be performed taking into consideration a position of the own vehicle M acquired from the navigation device 50 or a result of processing by the INS. The recognizer 130 recognizes the width of the road on which the own vehicle M is traveling. In this case, the recognizer 130 may recognize the width of the road from an image captured by the camera 10 or may recognize the width of the road from images of road lane lines obtained from the second map information 62. The recognizer 130 may also recognize the width of an obstacle (for example, the width of another vehicle), the height, the shape, or the like thereof on the basis of the image captured by the camera 10. The recognizer 130 also recognizes temporary stop lines, red lights, toll gates, and other road phenomena.

When recognizing the traveling lane, the recognizer 130 recognizes the position or attitude of the own vehicle M with respect to the traveling lane. For example, the recognizer 130 may recognize both a deviation from the lane center of the representative reference point of the own vehicle M and an angle formed by the travel direction of the own vehicle M relative to an extension line of the lane center as the relative position and attitude of the own vehicle M with respect to the traveling lane. Alternatively, the recognizer 130 may recognize the position of the representative point of the own vehicle M with respect to one of the sides of the traveling lane (a road lane line or a road boundary) or the like as the relative position of the own vehicle M with respect to the traveling lane. The recognizer 130 may also recognize structures on a road (for example, a utility pole and a median strip) on the basis of the first map information 54 or the second map information 62. The functions of the movement amount estimator 132 and the pedestrian attributes identification unit 134 of the recognizer 130 will be described later.

The behavior plan generator 140 generates a target trajectory along which the own vehicle M will travel in the future automatically (independently of the driver's operation), basically such that the own vehicle M travels in the recommended lane determined by the recommended lane determiner 61 and copes with situations occurring near the own vehicle M. The target trajectory is a trajectory through which the representative point of the own vehicle M is to pass. The target trajectory includes, for example, a speed element. The target trajectory is expressed, for example, by an arrangement of points (trajectory points) which are to be reached by the own vehicle M in order. The trajectory points are points to be reached by the own vehicle M at intervals of a predetermined travel distance (for example, at intervals of about several meters) along the road. Apart from this, a target speed and a target acceleration for each predetermined sampling time (for example, every several tenths of a second) are determined as a part of the target trajectory. The trajectory points may be respective positions at the predetermined sampling times which the own vehicle M is to reach at the corresponding sampling times. In this case, information on the target speed or the target acceleration is represented with the interval between the trajectory points.

When generating the target trajectory, the behavior plan generator 140 may set an automated driving event. Examples of the automated driving event include a constant-speed travel event, a low-speed following travel event, a lane change event, a branching event, a merging event, and a takeover event. The behavior plan generator 140 generates the target trajectory according to an activated event. The functions of a circumventing travel controller 142 in the behavior plan generator 140 will be described later.

The second controller 160 controls the travel driving force output device 200, the brake device 210, and the steering device 220 such that the own vehicle M passes through the target trajectory generated by the behavior plan generator 140 at scheduled times.

The second controller 160 includes, for example, an acquirer 162, a speed controller 164, and a steering controller 166. The acquirer 162 acquires information on the target trajectory (trajectory points) generated by the behavior plan generator 140 and stores it in a memory (not shown). The speed controller 164 controls the travel driving force output device 200 or the brake device 210 on the basis of the speed element included in the target trajectory stored in the memory. The steering controller 166 controls the steering device 220 according to the degree of curvature of the target trajectory stored in the memory. The processing of the speed controller 164 and the steering controller 166 is realized, for example, by a combination of feedforward control and feedback control. As one example, the steering controller 166 performs the processing by combining feedforward control according to the curvature of the road ahead of the own vehicle M and feedback control based on deviation from the target trajectory.

The travel driving force output device 200 outputs a travel driving force (torque) required for the vehicle to travel to driving wheels. The travel driving force output device 200 includes, for example, a combination of an internal combustion engine, an electric motor, a transmission, and the like and an ECU that controls them. The ECU controls the above constituent elements according to information input from the second controller 160 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second controller 160 or information input from the driving operators 80 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. The brake device 210 is not limited to that configured as described above and may be an electronically controlled hydraulic brake device that controls an actuator according to information input from the second controller 160 and transmits the hydraulic pressure of the master cylinder to the cylinder.

The steering device 220 includes, for example, a steering ECU and an electric motor. The electric motor, for example, applies a force to a rack-and-pinion mechanism to change the direction of the steering wheel. The steering ECU drives the electric motor according to information input from the second controller 160 or information input from the driving operators 80 to change the direction of the steering wheel.

### [Functions of Circumventing Travel Controller]

When the recognizer 130 has recognized that a pedestrian is present ahead in the travel direction on a road on which the own vehicle M is traveling, the circumventing travel controller 142 performs control for circumventing the pedestrian. Hereinafter, only the case in which the own vehicle M overtakes and circumvents a pedestrian who is moving in the same direction as the travel direction of the own vehicle M will be illustrated and described. However, the present invention is not limited to such a case and can be applied in the same way to the case in which the own vehicle M avoids and circumvents a pedestrian moving in the opposite direction to the travel direction of the own vehicle M.

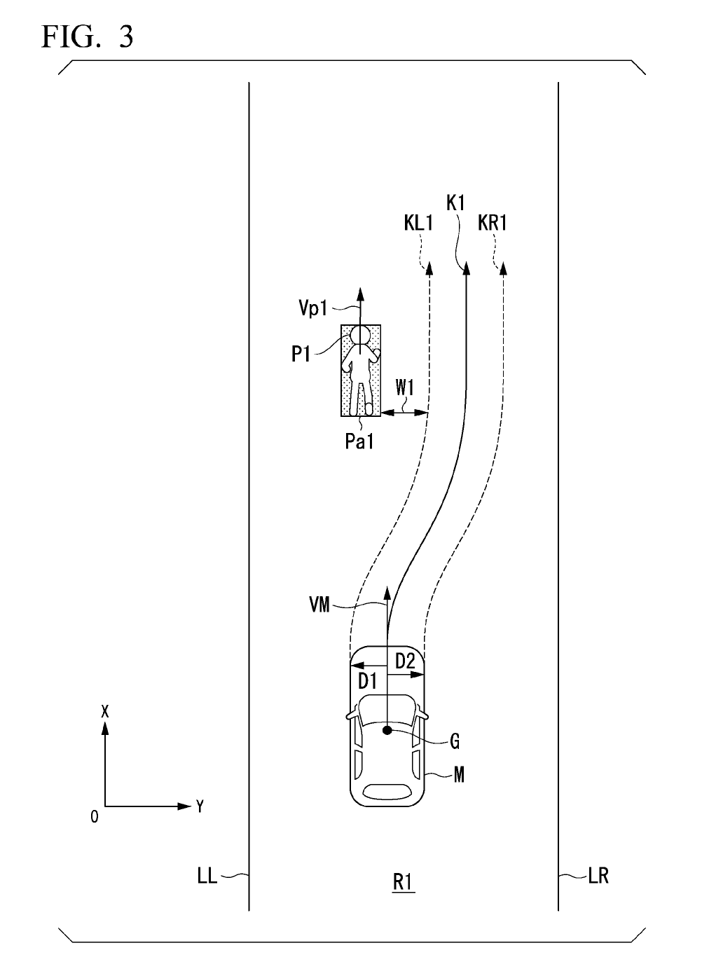

When the recognizer 130 has recognized that pedestrians are present ahead in the travel direction on the road on which the own vehicle M is traveling, the circumventing travel controller 142 generates a target trajectory for the own vehicle M to overtake the pedestrian on the basis of the number of pedestrians present. FIG. 3 is a diagram showing an example of processing of the circumventing travel controller 142 when a single pedestrian is present ahead in the travel direction of the own vehicle M. In the example of FIG. 3, it is assumed that a single pedestrian P1 is present ahead in the travel direction of the own vehicle M which is traveling on a road R1 defined by left and right road lane lines LL and LR. The single pedestrian is, for example, a pedestrian who is separated from other pedestrians by a predetermined distance (for example, about several meters) or more. In the example of FIG. 3, it is assumed that the own vehicle M performs overtaking driving by passing the right side of the pedestrian P1.

For example, when the recognizer 130 has recognized the pedestrian P1 present ahead in the travel direction of the own vehicle M, the circumventing travel controller 142 sets an inferred contact area Pa1 in which it is inferred that the own vehicle M may may come into contact with the pedestrian P1 on the basis of contour information of the pedestrian P1. The circumventing travel controller 142 generates a target trajectory K1 for overtaking the pedestrian P1 without coming into contact with the set inferred contact area Pa1.

First, the circumventing travel controller 142 temporarily sets a target trajectory K1 along which the center of the own vehicle M (for example, the center of gravity G) is to pass and generates a left offset trajectory KL1 which is offset from the temporarily set target trajectory K1 in the lateral direction (the width direction of the road; the Y direction in the figure) by a distance D1 from the center of the own vehicle M to a left end portion of the own vehicle M. Then, in the case of overtaking the pedestrian P1 to the right side thereof, the circumventing travel controller 142 generates a target trajectory K1 such that the distance between the left offset trajectory KL1 and the inferred contact area Pa1 is equal to or greater than a first minimum interval W1.

In addition to the left offset trajectory KL1, the circumventing travel controller 142 may generate a right offset trajectory KR1 which is offset from the temporarily set target trajectory K1 in the lateral direction by a distance D2 from the center of the own vehicle M to a right wheel of the own vehicle M. In this case, the circumventing travel controller 142 generates a target trajectory K1 such that the distance between the left offset trajectory KL1 and the inferred contact area Pa1 is equal to or greater than the first minimum interval W1 and the right offset trajectory KR1 does not pass beyond the road lane line LR. This allows the own vehicle M to overtake the pedestrian P1 without deviating out of the road R1.

If the recognizer 130 recognizes that a plurality of pedestrians are present ahead in the travel direction of the own vehicle M and thus the circumventing travel controller 142 performs control for overtaking the plurality of recognized pedestrians, the circumventing travel controller 142 makes the distance between the own vehicle M and a pedestrian closest to the own vehicle M equal to or greater than a second minimum interval which is greater than the first minimum interval W1. The plurality of pedestrians may be, for example, two or more pedestrians who are present with less than a predetermined distance (for example, about several meters) therebetween. The plurality of pedestrians may also be two or more pedestrians whose movement direction or movement speed is within a predetermined range or who are present at a series of positions along the lateral direction with less than a predetermined distance therebetween. “Closest” may be based on, for example, the distance from the perimeter of the own vehicle M, the distance from the center of gravity of the own vehicle M, or the distance from the recognizer of the own vehicle M (for example, the camera 10, the radar device 12, or the finder 14).

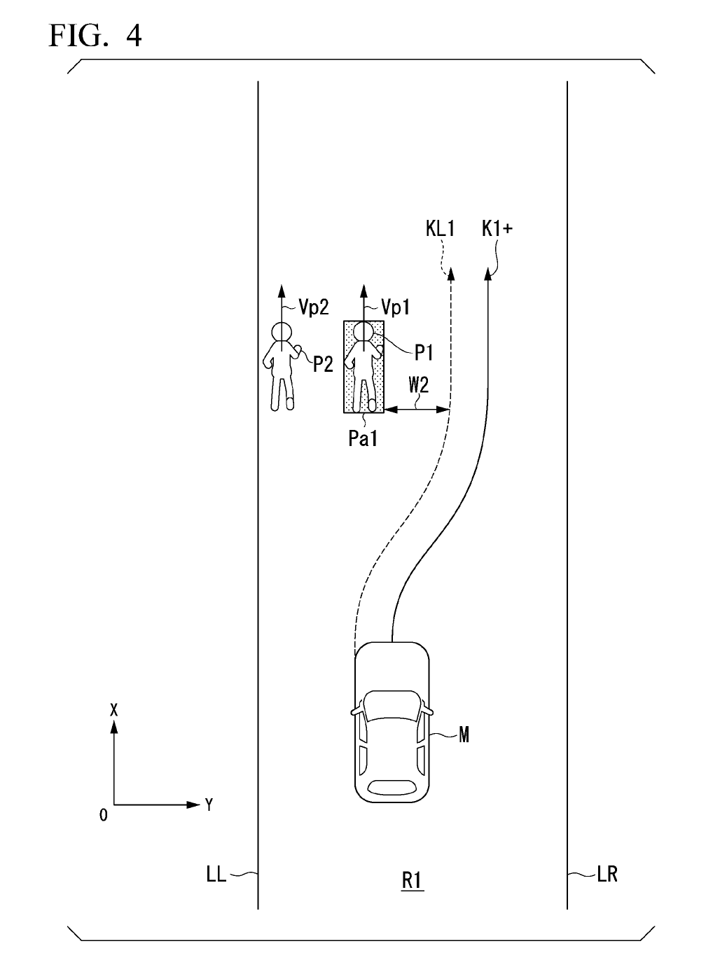

FIG. 4 is a diagram showing an example of processing of the circumventing travel controller 142 when a plurality of pedestrians are present ahead in the travel direction of the own vehicle M. In the example of FIG. 4, it is assumed that a plurality of pedestrians P1 and P2 are present ahead in the travel direction of the own vehicle M which is traveling on the road RE In this case, the circumventing travel controller 142 generates a target trajectory for the own vehicle M to overtake the pedestrians P1 and P2.

In the case of generating a target trajectory for the own vehicle M to overtake the pedestrians P1 and P2, the circumventing travel controller 142 generates a target trajectory K1+ for overtaking the pedestrians P1 and P2 without coming into contact with an inferred contact area Pa1 of the pedestrian P1 closest to the own vehicle M as shown in FIG. 4. Specifically, in the case of overtaking the plurality of pedestrians P1 and P2, the circumventing travel controller 142 makes the distance between the left offset trajectory KL1 and the inferred contact area Pa1 equal to or greater than a second minimum interval W2 which is greater than the first minimum interval W1 and generates a target trajectory K1+ such that the left offset trajectory KL1 passes through positions at which the distance is equal to or greater than the second minimum interval W2. The second minimum interval W2 may be increased by a fixed interval (for example, about 0.5 meters) as compared to the first minimum interval W1 or may be increased by an interval based on a stride length of the pedestrian P1 recognized by the recognizer 130.

When a plurality of pedestrians are present, the behavior of one of the pedestrians may cause the behavior of the other pedestrians to spread in a chain-like manner such that the pedestrians may move to a greater extent than when a single pedestrian is present. Therefore, by increasing the distance between the own vehicle M and a pedestrian closest to the own vehicle M as compared to when a single pedestrian is present as described above, it is possible to reduce the likelihood of contact with pedestrians and thus to perform more appropriate driving control.

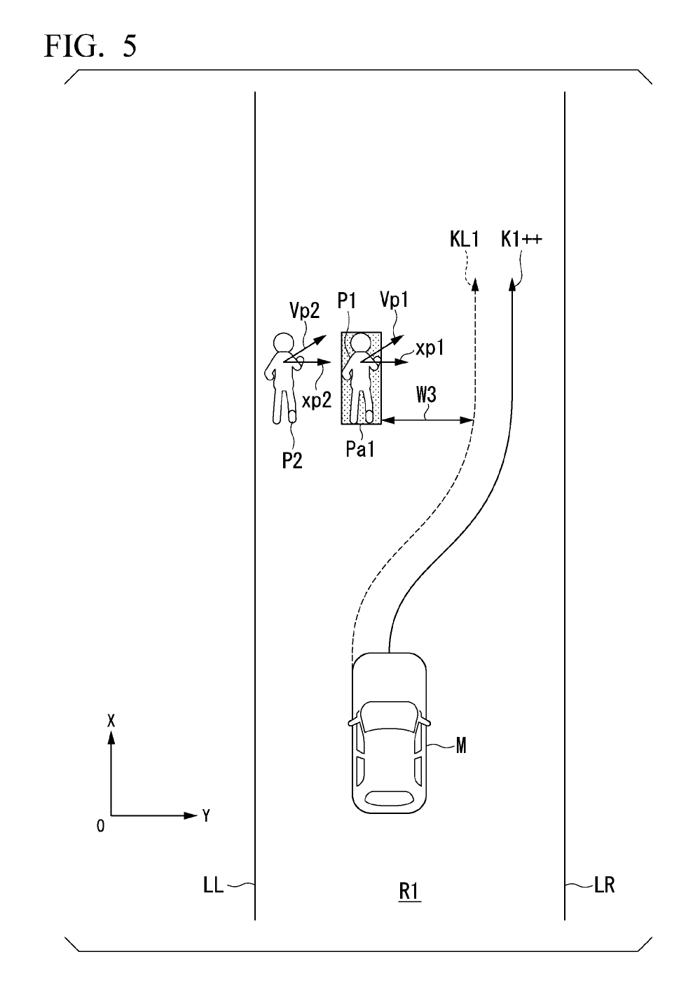

When the recognizer 130 has recognized that a plurality of pedestrians are present ahead in the travel direction of the own vehicle M, the circumventing travel controller 142 may adjust the second minimum interval on the basis of the amount of movement of each of the plurality of pedestrians in the lateral direction estimated by the movement amount estimator 132. FIG. 5 is a diagram showing an example of processing of the circumventing travel controller 142 based on the amount of movement of a plurality of pedestrians in the lateral direction. In the example of FIG. 5, it is assumed that the pedestrians P1 and P2 are walking at velocities Vp1 and Vp2 in a diagonal right-forward direction. The pedestrian P1 is present closer to the center in the width direction (Y direction in the figure) of the road RE The pedestrian P2 is present further from the center in the width direction of the road R1 (Y direction in the figure).

### [Functions of Movement Amount Estimator]

When the recognizer 130 has recognized that a plurality of pedestrians P1 and P2 are present ahead in the travel direction of the own vehicle M, the movement amount estimator 132 estimates the amounts of movement xp1 and xp2 in the lateral direction among the respective amounts of movement of the plurality of pedestrians P1 and P2. The amounts of movement xp1 and xp2 are, for example, the amounts of movement of the pedestrians P1 and P2 in the lateral direction from outside of the road R1 (for example, the lane line LL) toward the inside thereof (for example, the center of the road). The amounts of movement xp1 and xp2 may also be the amounts of movement of the pedestrians P1 and P2 in the lateral direction toward the side on which the own vehicle M overtakes the pedestrians P1 and P2.

The movement amount estimator 132 may determine whether or not the pedestrian P2 is approaching the pedestrian P1 on the basis of the respective amounts of movement xp1 and xp2. In this case, for example, the movement amount estimator 132 derives the relative amount of movement xr (=xp2−xp1) of the pedestrian P2 in the lateral direction relative to the pedestrian P1 and determines that the pedestrian P2 is approaching the pedestrian P1 when the derived relative amount of movement xr is greater than zero (0) and determines that the pedestrian P2 is not approaching the pedestrian P1 when the derived relative amount of movement xr is equal to or less than zero.

When the movement amount estimator 132 has determined that the pedestrian P2 is approaching the pedestrian P1, the circumventing travel controller 142 makes the distance between the own vehicle M and the pedestrian P1 equal to or greater than a third minimum interval W3 which is greater than the second minimum interval W2 as shown in FIG. 5. In this manner, when the pedestrian P2 has approached the pedestrian P1, it is predicted that the pedestrian P1 will move further in the lateral direction in the future than at the current time and thus the minimum interval is increased, whereby it is possible to reduce the likelihood of contact with pedestrians in the future and thus to perform more appropriate driving control.

When the movement amount estimator 132 has determined that the pedestrian P2 is not approaching the pedestrian P1, the circumventing travel controller 142 may leave the distance between the own vehicle M and the pedestrian P1 unchanged from the second minimum interval W2 or may adjust the second minimum interval W2 on the basis of the magnitude of the relative amount of movement xr. In this case, if the relative amount of movement xr has a negative value, the pedestrian P1 is less affected by the behavior of the pedestrian P2 since the distance between the pedestrian P1 and the pedestrian P2 is increasing. Therefore, the circumventing travel controller 142 adjusts the second minimum interval W2 to within a range less than the third minimum interval W3 on the basis of the amount of movement xp1 of the pedestrian P1.

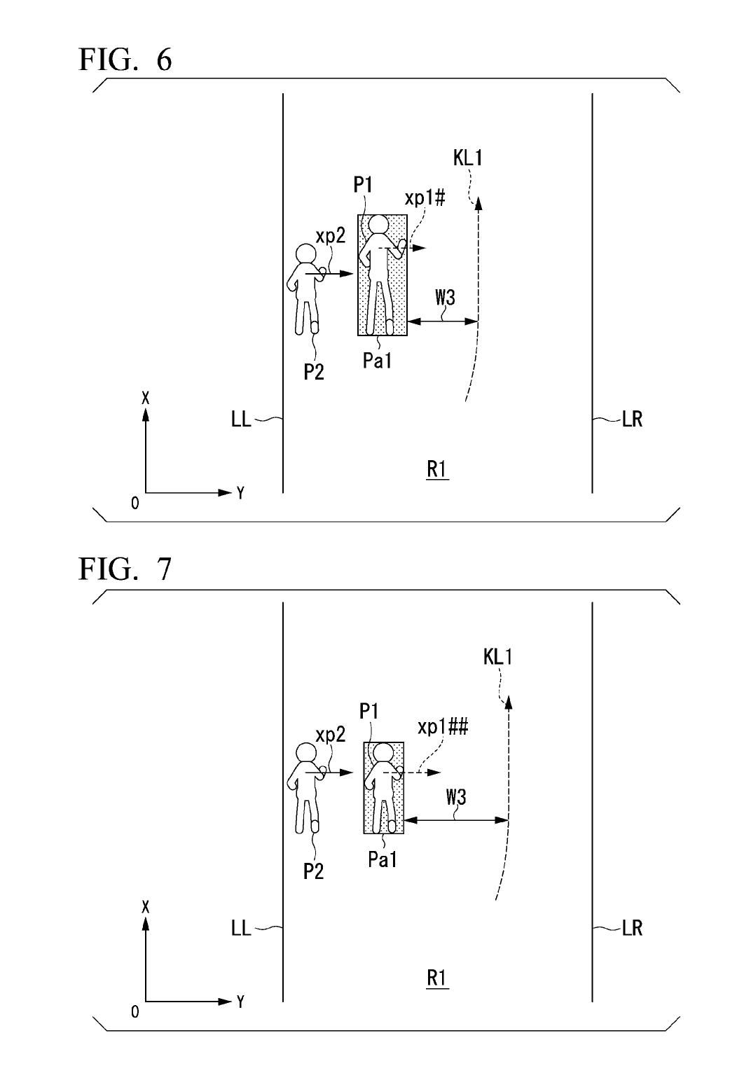

The circumventing travel controller 142 may adjust the third minimum interval W3 on the basis of attributes of pedestrians determined by the pedestrian attributes identification unit 134. FIG. 6 is a (first) diagram showing an example of processing of the circumventing travel controller 142 based on attributes of pedestrians.

### [Functions of Pedestrian Attributes Identification Unit]

When the recognizer 130 has recognized that a plurality of pedestrians are present ahead in the travel direction of the own vehicle M, the pedestrian attributes identification unit 134 identifies the attributes of each pedestrian. An attribute is, for example, a result of determination as to whether the pedestrian is an adult or a child. An attribute may also be a result of identifying sex and age. For example, the pedestrian attributes identification unit 134 analyzes an image captured by the camera 10, estimates the height of each of a plurality of pedestrians present ahead in the travel direction of the own vehicle M included in the image, identifies a pedestrian whose height is equal to or greater than a predetermined value as an adult, and identifies a pedestrian whose height is less than the predetermined value as a child.

The pedestrian attributes identification unit 134 may identify the attributes on the basis of the clothes of the pedestrian. In this case, the pedestrian attributes identification unit 134 analyzes the image captured by the camera 10 and identifies the pedestrian as a child upon determining from the analysis results that the pedestrian is carrying a school bag. The pedestrian attributes identification unit 134 may also determine the proportions of the attributes of the plurality of pedestrians (for example, 25% for adults and 75% for children).

In the example of FIG. 6, it is assumed that the pedestrian attributes identification unit 134 has identified a pedestrian P1 as an adult and identified a pedestrian P2 as a child. It is also assumed that the movement amount estimator 132 has estimated the amount of movement xp2 of the pedestrian P2 in the lateral direction. In this scenario, it is predicted that the amount of movement xp1# of the pedestrian P1 in the lateral direction in the future due to the amount of movement xp2 of the pedestrian P2 will be smaller than the amount of movement xp2 since the pedestrian P1 is an adult. Therefore, the circumventing travel controller 142 derives the amount of movement xp1# of the pedestrian P1 in the lateral direction in the future by multiplying the amount of movement xp2 of the pedestrian P2 by a factor less than 1. Then, the circumventing travel controller 142 adjusts the third minimum interval W3 on the basis of the magnitude of the derived amount of movement xp1#.

FIG. 7 is a (second) diagram showing an example of processing of the circumventing travel controller 142 based on attributes of pedestrians. In the example of FIG. 7, it is assumed that the pedestrian attributes identification unit 134 has identified pedestrians P1 and P2 as children. It is also assumed that the movement amount estimator 132 has estimated the amount of movement xp2 of the pedestrian P2 in the lateral direction. In this scenario, when the pedestrian P2 has moved by the amount of movement xp2 in the lateral direction, it is predicted that the pedestrian P2 will move greatly in the lateral direction due to the amount of movement xp2 of the approaching pedestrian P2 since the pedestrian P1 is also a child. Therefore, the circumventing travel controller 142 derives the future amount of movement xp1## of the pedestrian P1 in the lateral direction, for example, by multiplying the amount of movement xp2 of the pedestrian P2 by a factor greater than 1. Then, the circumventing travel controller 142 adjusts the third minimum interval W3 on the basis of the magnitude of the derived amount of movement xp1##. Specifically, the circumventing travel controller 142 increases the amount of adjustment of the third minimum interval W3 based on the amount of movement xp1## as compared to that based on the amount of movement xp1#.

When the pedestrian P1 is identified as a female adult by the pedestrian attributes identification unit 134, the circumventing travel controller 142 may increase the third minimum interval W3 as compared to when the pedestrian P1 is identified as a male adult. When the pedestrian P1 is identified as an elderly person (for example, a 60 years old or older person) by the pedestrian attributes identification unit 134, the circumventing travel controller 142 may increase the third minimum interval W3 as compared to when the pedestrian P1 is identified as a 30 years old person. The circumventing travel controller 142 may also increase the third minimum interval W3 on the basis of the proportions of attributes of the plurality of pedestrians identified by the pedestrian attributes identification unit 134.

In this manner, by adjusting the third minimum interval on the basis of the attributes of the plurality of pedestrians or the proportions of attributes of the plurality of pedestrians, it is possible to keep the distance between the own vehicle M and the pedestrians at an appropriate interval according to chain-like spreading of the amounts of movement of the pedestrians corresponding to the attributes of the pedestrians.

The circumventing travel controller 142 may increase the third minimum interval W3 as the number of pedestrians present ahead in the travel direction of the own vehicle M increases. When three or more pedestrians are present, the circumventing travel controller 142 may derive the amounts of movement of pedestrians other than a pedestrian closest to the own vehicle M, predict the amount of movement of the pedestrian closest to the own vehicle M on the basis of the average, the maximum, or the like of the derived amounts of movement, and adjust the third minimum interval W3 on the basis of the predicted amount of movement. The circumventing travel controller 142 may also adjust the third minimum interval W3 on the basis of the number and order of pedestrians moving in the lateral direction among the three or more pedestrians.

### [Process Flow]

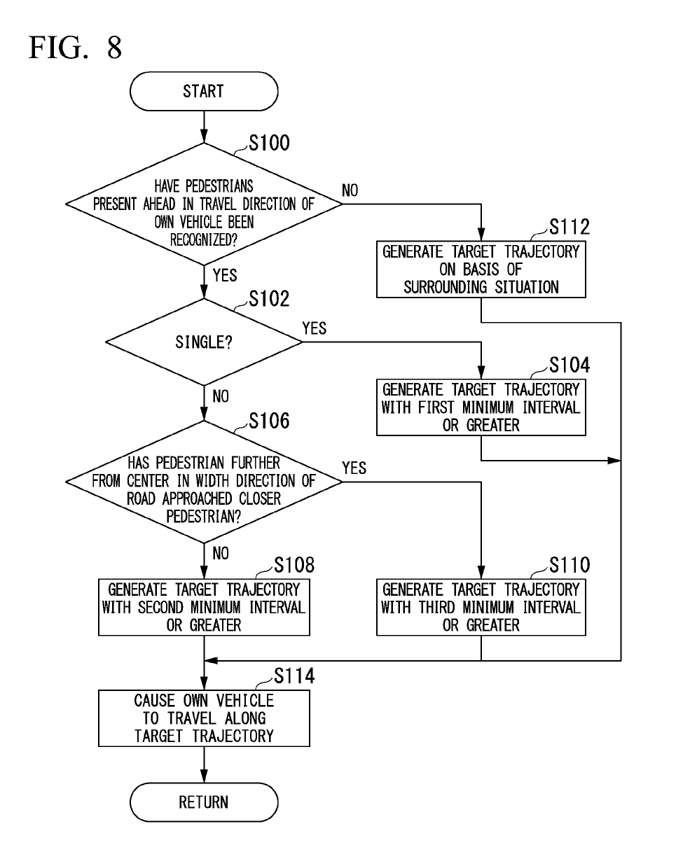

FIG. 8 is a flowchart showing the flow of processes executed by the automated driving control device 100 according to an embodiment. The process of this flowchart may be repeatedly performed at a predetermined cycle or at predetermined timings. When this flowchart starts, it is assumed that the behavior plan generator 140 has generated a target trajectory and the second controller 160 is performing automated driving on the basis of the generated target trajectory.

In the example of FIG. 8, the behavior plan generator 140 determines whether or not pedestrians present ahead in the travel direction of the own vehicle M have been recognized by the recognizer 130 (step S100). When it is determined that pedestrians have been recognized, it is determined whether or not the number of the pedestrians is one (step S102). If the number of the pedestrians is one, the circumventing travel controller 142 generates a target trajectory such that the distance between the own vehicle M and the pedestrian is equal to or greater than a first minimum interval (step S104).

If the number of the pedestrians is not one, it is determined whether or not a pedestrian further from the center in the width direction of the road among the pedestrians is approaching a closer pedestrian (step S106). When it is determined that a pedestrian further from the center in the width direction of the road is not approaching a closer pedestrian, the circumventing travel controller 142 generates a target trajectory such that the distance between the own vehicle M and a pedestrian closest to the own vehicle M is equal to or greater than a second minimum interval which is greater than the first minimum interval (step S108). When it is determined that a pedestrian further from the center in the width direction of the road is approaching a closer pedestrian, the circumventing travel controller 142 generates a target trajectory such that the distance between the own vehicle M and the pedestrian closest to the own vehicle M is equal to or greater than a third minimum interval which is greater than the second minimum interval (step S110).

Upon determining in step S100 that no pedestrians present ahead in the travel direction of the own vehicle M have been recognized, the behavior plan generator 140 generates a target trajectory on the basis of the surrounding situation (step S112). Next, the second controller 160 causes the own vehicle M to travel along the target trajectory generated by the process of step S104, S108, S110, or S112 (step S114). Then, the process of this flowchart ends.

According to the embodiment described above, the vehicle control device includes the recognizer 130 configured to recognize the surrounding situation of the own vehicle M and the driving controller 140 or 160 configured to automatically control at least steering of the own vehicle M on the basis of the surrounding situation recognized by the recognizer 130, wherein the driving controller 140 or 160 is configured to, when the recognizer 130 has recognized a single pedestrian ahead in the travel direction of the own vehicle M, make the distance between the own vehicle M and the pedestrian equal to or greater than a first minimum interval and to, when the recognizer 130 has recognized a plurality of pedestrians ahead in the travel direction of the own vehicle M, make the distance between the own vehicle M and a pedestrian closest to the own vehicle M equal to or greater than a second minimum interval which is greater than the first minimum interval, whereby it is possible to more appropriately perform driving control for avoiding contact with pedestrians present ahead in the travel direction of the own vehicle M.

Specifically, according to the present embodiment, when a plurality of pedestrians are present ahead in the travel direction of the own vehicle M, control is performed such that the minimum interval with respect to the pedestrians is greater than when a single pedestrian is present, whereby it is possible to keep an appropriate interval taking into consideration chain-like spreading of the movement of the plurality of pedestrians.

### [Hardware Configuration]

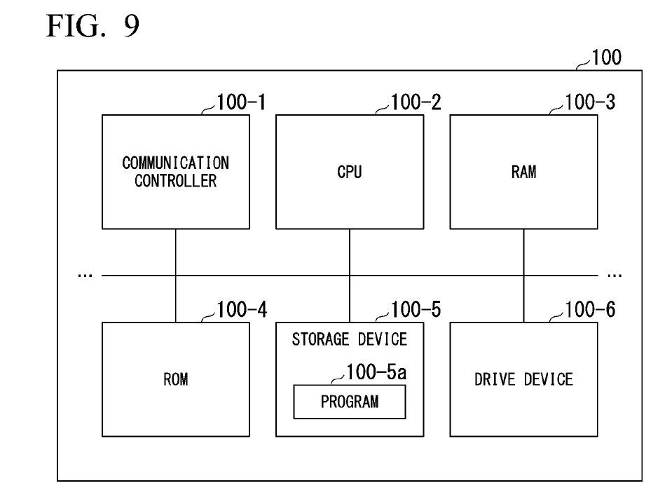

FIG. 9 is a diagram showing an example of the hardware configuration of the automated driving control device 100 according to an embodiment. As shown, the automated driving control device 100 is configured such that a communication controller 100-1, a CPU 100-2, a RAM 100-3 used as a working memory, a ROM 100-4 storing a boot program or the like, a storage device 100-5 such as a flash memory or an HDD, a drive device 100-6, or the like are connected to each other via an internal bus or a dedicated communication line. The communication controller 100-1 performs communication with components other than the automated driving control device 100. A portable storage medium such as an optical disc (for example, a computer readable non-transitory storage medium) is mounted in the drive device 100-6. The storage device 100-5 stores a program 100-5a to be executed by the CPU 100-2. This program is loaded in the RAM 100-3 by a direct memory access (DMA) controller (not shown) or the like and then executed by the CPU 100-2. The program 100-5a referred to by the CPU 100-2 may be stored in the portable storage medium mounted in the drive device 100-6 or may be downloaded from another device via a network. Thereby, some or all of the first controller 120 and the second controller 160 of the automated driving control device 100 are realized.

The embodiments described above can be expressed as follows.

A vehicle control device including:

a storage device configured to store a program; and

a hardware processor,

wherein the hardware processor is configured to execute the program stored in the storage device to:

recognize a surrounding situation of a vehicle;

automatically control at least steering of the vehicle on the basis of the recognized surrounding situation; and

automatically control the steering of the vehicle such that, when a single pedestrian ahead in a travel direction of the vehicle has been recognized, a distance between the vehicle and the pedestrian is equal to or greater than a first minimum interval and, when a plurality of pedestrians ahead in the travel direction of the vehicle have been recognized, the distance between the vehicle and a pedestrian closest to the vehicle is equal to or greater than a second minimum interval which is greater than the first minimum interval.

Although the modes for carrying out the present invention have been described above by way of embodiments, the present invention is not limited to these embodiments at all and various modifications and substitutions can be made without departing from the gist of the present invention.

What is claimed is:

1. A vehicle control device comprising:
a recognizer configured to recognize a surrounding situation of a vehicle; and
a driving controller configured to automatically control at least steering of the vehicle on the basis of the surrounding situation recognized by the recognizer,
wherein the driving controller is configured to, when the recognizer has recognized a single pedestrian ahead in a travel direction of the vehicle, make a distance between the vehicle and the pedestrian equal to or greater than a first minimum interval and to, when the recognizer has recognized a plurality of pedestrians ahead in the travel direction of the vehicle, make the distance between the vehicle and a pedestrian closest to the vehicle equal to or greater than a second minimum interval which is greater than the first minimum interval.

2. The vehicle control device according to claim 1, wherein the driving controller is configured to, when the recognizer has recognized a plurality of pedestrians ahead in the travel direction of the vehicle, adjust the second minimum interval on the basis of respective amounts of movement of the plurality of recognized pedestrians in a width direction of a road.

3. The vehicle control device according to claim 1, wherein the driving controller is configured to, when the recognizer has recognized a plurality of pedestrians ahead in the travel direction of the vehicle and a pedestrian present further from a center in a width direction of a road among the plurality of pedestrians has approached a pedestrian present closer to the center in the width direction of the road, make the distance between the vehicle and a pedestrian closest to the vehicle equal to or greater than a third minimum interval which is greater than the second minimum interval.

4. The vehicle control device according to claim 3, wherein the driving controller is configured to adjust the second minimum interval or the third minimum interval on the basis of respective attributes of the plurality of pedestrians recognized by the recognizer.

5. A vehicle control method comprising:
a vehicle control device recognizing a surrounding situation of a vehicle;
automatically controlling at least steering of the vehicle on the basis of the recognized surrounding situation; and
automatically controlling the steering of the vehicle such that, when a single pedestrian ahead in a travel direction of the vehicle has been recognized, a distance between the vehicle and the pedestrian is equal to or greater than a first minimum interval and, when a plurality of pedestrians ahead in the travel direction of the vehicle have been recognized, the distance between the vehicle and a pedestrian closest to the vehicle is equal to or greater than a second minimum interval which is greater than the first minimum interval.

6. A computer readable non-transitory storage medium storing a program causing a vehicle control device to:
recognize a surrounding situation of a vehicle;
automatically control at least steering of the vehicle on the basis of the recognized surrounding situation; and
automatically control the steering of the vehicle such that, when a single pedestrian ahead in a travel direction of the vehicle has been recognized, a distance between the vehicle and the pedestrian is equal to or greater than a first minimum interval and, when a plurality of pedestrians ahead in the travel direction of the vehicle have been recognized, the distance between the vehicle and a pedestrian closest to the vehicle is equal to or greater than a second minimum interval which is greater than the first minimum interval.
